(19) United States
(12) Patent Application Publication
(10) Pub. No.: US 2009/0226578 A1
(43) Pub. Date: Sep. 10, 2009

(54) Method for preparing double-wide bacon

(76) Inventors: Gary Schulz, Carroll, IA (US); John Cool, Parkville, MO (US)

Correspondence Address: REED SMITH LLP, 2500 ONE LIBERTY PLACE, 1650 MARKET STREET, PHILADELPHIA, PA, 19103, US

(21) Appl. No.: 12/075,249

(22) Filed: Mar. 10, 2008

(51) Int. Cl. A23B 4/056; A23L 1/318

(52) U.S. Cl. 426/235; 426/645

(57) ABSTRACT

The present invention comprises double-wide bacon slices and a method for producing double-wide bacon. First the pork bellies are cured. Then, the bellies are massaged to release proteins. Two bellies are then aligned lean side to lean side, and pressure is applied which causes the slabs to attached to each other. Then the attached slabs are smoked, chilled and sliced.

### FIELD OF THE INVENTION

The present invention is a method for preparing slices of bacon which have the width of two original slices, and a double-wide slice of bacon. Currently, the food industry often makes sandwiches and platters with two or more slices of bacon, which is inefficient in terms of food preparation time. In the case of sandwiches, having multiple slices on one sandwich makes it difficult to eat neatly. The present invention addresses these problems.

### BACKGROUND

Conventionally, commercial producers of bacon offer slices of bacon which are about 10-11 inches long, about 1.5 inches wide, and about 1-2 mm thick (referred to as a “normal slice”). Some producers offer “thick” slices of bacon which are about 10-11 inches long, about 1.5 inches wide and about 4-5 mm thick (referred to as a “thick slice”). All dimensions of slices provided in this specification are the dimensions of the slices as sold to the consumer (before the slices are cooked by the consumer).

The width of a conventional bacon slice, when compared to the width of a conventional sandwich roll, is significantly narrower. This usually means that a consumer will desire multiple slices of bacon on a sandwich, so that there is bacon is almost every or every bite. The drawbacks of this are: (1) it is labor-intensive for the food service industry, cooking multiple slices of bacon per sandwich and (2) the sandwich may be difficult to eat because it is hard to anchor each slice while holding and biting the sandwich.

Thus, there is a need for a method for producing double-wide bacon, so that only one slice needs to be prepared and used per sandwich. Without limitation, the present invention produces bacon slices which are about 3 inches wide (about the total width of two slices of bacon), and can have the length and thickness of conventional or thick bacon slices.

### SUMMARY OF THE INVENTION

The present inventors have developed a method for preparing slices of bacon which are about two original slices (each slice is from a single slab) wide (also referred to herein as “double-wide”). These double-wide slices have the thickness of about a normal slice to about a thick slice. One of the benefits of this double-wide bacon is that rather than needing multiple slices of bacon on a sandwich, one slice could be cooked and cover a substantial part of the sandwich. This invention results in efficiencies in food preparation, requiring only cooking and stacking one slice of bacon instead of two slices. Further, the double-wide bacon is more easily held in a sandwich, and therefore the sandwich is easier to eat neatly.

While this invention uses pork bellies to produce double-wide bacon slices, it may also be applied to other cuts of meat such as boneless pork butts, ham muscles, boneless pork loins, boneless pork picnic meat, other pork products, or other meat products. It is possible to use slabs of two of the same or different kinds of meat (preferably the same) and attach them together through the present invention.

### FIGURES

FIG. 1 shows the present invention (1) next to the prior art (2).

FIG. 2 shows the process flow of the present invention.

FIG. 3 shows the present invention (9) next to the prior art (10) after each has been cooked by the consumer.

### DETAILED DESCRIPTION

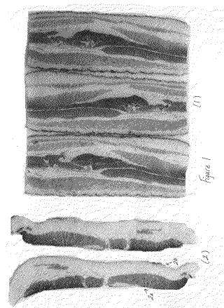

The present invention is a method for preparing double-wide bacon. In FIG. 1, the double-wide bacon (1) is displayed next to two prior art bacon slices (2).

While the prior art has produced thick bacon slices, it is surprising that this invention produces double-wide slices because there is significantly less surface area of the two slices touching, yet the slices are sufficiently attached by this method to remain substantially attached even through cooking by the consumer.

In the present invention, the double-wide slices are substantially free of all attachment materials, such as glue, pastes, sauces or other materials known in the art to attach two pieces of meat together.

Pork bellies (and ultimately slices of bacon) have a lean side and a fat side. “Lean side” (2a) is defined to mean the length-wise side of the slab or slice that contains more muscle than the other length-wise side. “Fat side” (2b) is defined to mean the length-wise side of the slab or slice other than the lean side.

In this specification, the term “smoking” includes smoking, cooking, or both smoking and cooking.

As reflected in FIG. 2, one embodiment of the present invention comprises curing two slabs of meat (3), preferably pork bellies. Curing as used in this specification includes but is not limited to injecting the slabs with a pickling brine. This pickling brine may also include any ingredient allowed by the USDA or combinations thereof in amounts effective to aid in the meat processing and/or achieve the desired flavor, textural properties and/or product performance. Then the slabs of meat are massaged (4). After the massaging, the slabs are aligned so that the lean side of each slab is adjacent to the lean side of the other slab. Preferably, without limitation, the flank end of one slab will be adjacent to the shoulder end of the other slab. The slabs may be touching each other once they are aligned or they may be placed so that they begin to touch as the pressure is applied. Pressure is then applied to the slabs, so that the slabs are touching and compressed together (preferably one on top of the other), causing the slabs to attach together lean side to lean side (5). The application of pressure may, without limitation, result in an expansion of the slabs lengthwise or widthwise, and may, without limitation, result in a non-rectangular shape to the attached slabs. The attached slabs are then smoked (6) at about 130—about 150° F., (preferably about 140° F.) for about 4—about 8 hours (preferably about 6 hours). Then the attached slabs are chilled (7) to about 22° F.—about 32° F. (preferably about 26° F.) for at least about 6 hours (preferably at least about 12 hours). Finally, the attached slabs are sliced into individual slices (8) preferably, without limitation, about 1—about 5 mm thick.

Without being limited to the mechanism of action, it is believed that the massaging causes proteins to be extracted from the slabs, by breaking down the cells, and these proteins behave as the glue that holds the muscle pieces together. One of ordinary skill in the art would recognize that the massaging may occur in any apparatus effective to massage the meat sufficiently to permit the attachment of the two slabs after the application of pressure, and to maintain the attachment during smoking, and chilling. This invention may employ the means by which other meat products, such as ham, are similarly massaged.

In one embodiment, the massaging occurs at about 20″ Hg to about 28″ Hg, preferably about. 26″ Hg and at temperatures of from just above freezing to about 45° F., preferably about 34° F., for about 1—about 8 hours, preferably about 1—about 3 hours. The massaging may occur on a single slab, or both slabs, preferably on both slabs.

In one embodiment, before massaging the slabs, the slabs may be process to score the lean surfaces, needle tenderize the slabs, and/or otherwise prepare the slabs to improve the protein extraction. One or more of these processes may be achieved by a series of knives, needles, and/or textured plates, as is known to one of ordinary skill in the art.

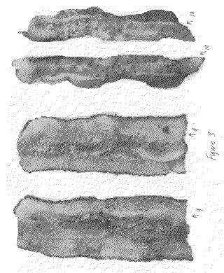

In one embodiment, the slabs remain substantially attached to each other through smoking, chilling, slicing, and cooking by the consumer. In FIG. 3, the double-wide bacon (9) and the prior art bacon (10) were cooked like a consumer would cook bacon. The double-wide bacon stayed attached through the consumer's cooking process, and did not separate, break or crumbled.

In one embodiment, the attached slabs remain under the applied pressure throughout the smoking and/or chilling steps.

In one embodiment, the smoking preferably occurs at an elevated temperature compared to prior art bacon smoking in order to further strengthen the attachment of the attached slabs.

In an embodiment, the smoking and/or cooking occurs with the attached slab aligned so that the two slabs are one on top of the other.

The pressure in this invention may be applied by any apparatus known in the art to apply pressure, including but not limited to, via one or more screens, presses, springs, weights or any apparatus known to those skilled in the art for pressing meat products.

Another embodiment comprises curing two slabs of meat, preferably pork bellies (3). Then the slabs of meat are massaged (4). After the massaging, the slabs are aligned so that the lean side of each slab is adjacent to the lean side of the other slab. This aligning may occur simultaneously, before or after the slabs are placed into a net. The net is used to hold the slabs in alignment, preventing the slabs from slipping with respect to each other. (In other embodiments, other devices may be used that function similarly to the net.) The net preferably does not cause the slabs' width or length to be constrained during the application of pressure. Pressure is then applied to the slabs, causing the slabs to attach together lean side to lean side, preferably at substantially the edge of each lean side (5). The pressure is applied until a specified thickness of the attached slabs is achieved. The attached slabs are then smoked (6) at about 130—about 150° F., preferably about 140° F. for about 4—about 8 hours, preferably about 6 hours. Then the attached slabs are chilled (7) to about 22°—about 32° F., preferably about 26° F. for at least about 6 hours, preferably at least about 12 hours. Finally, the attached slabs are sliced into individual slices (8) preferably, without limitation, about 1—about 5 mm thick.

The present invention may be embodied in other specific forns without departing from its essential characteristics. The described embodiment is to be considered in all respects only as illustrative and not as restrictive. The scope of the present invention is, therefore, indicated by the appended claims rather than by the foregoing description. All changes which come within the meaning and range of the equivalence of the claims are to be embraced within their scope.

What is claimed is:

1. A method for producing double-wide bacon comprising
Curing a first and a second slab of meat;
Massaging at least one of the slabs;
Aligning the slabs with a first lean side of the first slab adjacent to a second lean side of the second slab;
Applying pressure to the slabs to attach the slabs together;
Smoking the attached slabs;
Chilling the attached slabs.

2. The method of claim 1 wherein the aligning takes place in a net.

3. The method of claim 1 wherein the meat comprises pork bellies.

4. The method of claim 1 wherein the curing comprises injecting the slabs.

5. The method of claim 1 wherein the massaging occurs at a pressure of about 20″ Hg to about 28″ Hg at a temperature of from just above freezing to about 45° F. for at least about 1 hour.

6. The method of claim 1 wherein the massaging occurs at about 34° F. and about 26″ Hg for about 1—about 3 hours.

7. The method of claim 1 wherein the smoking consists of cooking.

8. The method of claim 1 further comprising slicing the attached slabs.

9. The method of claim 8 wherein the curing, massaging, aligning, applying pressure, smoking, chilling and slicing occur sequentially.

10. The method of claim 1 wherein the aligning further comprises locating the flank end of one slab adjacent to the shoulder end of the other slab.

11. The method of claim 1 further comprising macerating one or more slabs before the massaging.

12. The method of claim 11 wherein the macerating is achieved via one or more knives.

13. The method of claim 11 wherein the macerating is achieved via one or more needles.

14. The method of claim 11 wherein the macerating is achieved via one or more textured plates.

15. The method of claim 11 wherein the applying pressure continues during the smoking.

16. The method of claim 11 wherein the applying pressure continues during the chilling.

17. The method of claim 1 wherein one slab touches the other slab during the aligning.

18. The method of claim 1 wherein one slab touches the other slab during the applying pressure.

19. The method of claim 1 wherein the smoking occurs at about 130°—about 150° F. for about 4—about 8 hours.

20. The method of claim 1 wherein the chilling occurs at about 22°—about 32° F. for at least about 6 hours.

21. The method of claim 1 wherein the applying pressure occurs until a specified thickness of the attached slabs is attained.

22. The method of claim 1 wherein the meat comprises one or more of the group consisting of boneless pork butts, ham muscles, boneless pork loins, and boneless pork picnic meat.

23. A method for producing double-wide bacon comprising
Massaging a first slab of meat;
Aligning a first lean side of the first slab adjacent to a second lean side of a second slab of meat; and
Applying pressure to the slabs to attach the slabs together.

24. A double-wide slice of bacon comprising
A first part;
A second part, wherein the first and second parts are attached at a first lean side of the first part and a second lean side of the second part and wherein the first and second parts are attached with one or more proteins, and wherein the proteins are massaged from the first part and the second part.

25. The slice of claim 24 wherein the parts are attached via an application of pressure.

26. The slice of claim 24 wherein the parts are substantially free of all attachment materials.
